(19) United States
(12) Patent Application Publication
(10) Pub. No.: US 2026/0182603 A1
(43) Pub. Date: Jul. 2, 2026

(54) ADDITIVE COMPOSITION FOR A CONSUMABLE, A CONSUMABLE CONTAINING THE ADDITIVE COMPOSITION AND PROCESSES OF MAKING AND USING THE SAME

(71) Applicant: GIVAUDAN SA, VERNIER (CH)

(72) Inventors: Tarun BHOWMIK, Cincinnati, OH (US); Stefka Ivanova MYAKA, Cincinnati, OH (US); Spring SPAETH, Cincinnati, OH (US); Laura STIDHAM, Cincinnati, OH (US); Suman KHARB, Cincinnati, OH (US)

(21) Appl. No.: 19/130,204

(22) PCT Filed: Nov. 28, 2023
(86) PCT No.: PCT/EP2023/083328

§ 371 Date: May 15, 2025

Related U.S. Application Data
(60) Provisional application No. 63/429,055, filed on Nov. 30, 2022.

(51) Int. Cl. A23J 3/34; A23C 20/02; A23J 3/14; A23L 27/10; A23L 33/135; A23L 33/145

(52) U.S. Cl. CPC A23J 3/34; A23C 20/025; A23J 3/14; A23L 27/10; A23L 33/135; A23L 33/145

(57) ABSTRACT

An additive composition for a consumable and a consumable containing the additive composition. The additive composition functions as a flavour modifying ingredient to modify the taste and mouthfeel of a consumable and as a postbiotic to confer a health benefit on a subject that ingests the consumable. Processes for preparing an additive composition and the consumable containing the additive composition are also disclosed. Process and uses of the additive composition for improving the organoleptic properties of a consumable containing the additive composition and for conferring a health benefit to a subject with a consumable containing the additive composition.

### TECHNICAL FIELD

The present disclosure relates to an additive composition for a consumable, a process for preparing an additive composition, a consumable containing the additive composition, a process for making a consumable containing the additive composition, a process for improving the organoleptic properties of a consumable with the additive composition, and a process for providing a health benefit to a subject with a consumable containing the additive composition.

### BACKGROUND

Plant-based dairy alternatives are gaining global acceptance as replacement products for counterpart animal-based products. However, plant-based proteins used in dairy alternatives often come with undesirable off-notes. Each plant protein has its own natural characteristic profile of substances, such as aromas, depending on the origin and quality of the source, and these notes sometimes exhibit an undesirable taste profile such as beany, grainy, bitter, or astringent. Taste is usually the most important factor in a consumer's decision to purchase and repurchase of plant-based dairy alternatives. The issue of undesirable off-notes of plant-based dairy alternatives must be addressed to make such products more palatable and appealing to consumers and further global acceptance and growth.

Animal meat has always been associated with the increased risk of certain health conditions such as cancer and heart disease. The continued consumption of animal meat products also presents environmental issues relating to the emission of greenhouse gases and social issues relating to animal welfare.

A meat analogue is a food product that approximates the aesthetic properties (for example, appearance, flavor, and texture), chemical characteristics and cooking properties of certain types of meat. Meat analogues are also referred to in the food industry as animal protein analogues, meat alternatives, meat substitutes, mock meat, faux meat, imitation meat, vegetarian meat, or vegan meat. Meat analogues are increasingly desired by health-conscious non-vegetarians, vegetarians, vegans, persons following religious dietary restrictions, persons seeking reduction of fat in their diet, persons seeking to reduce or eliminate consumption of processed real meat, and others seeking to reduce consumption of meat for other ethical or nutritional reasons. However, meat analogues typically lack authentic meaty taste and nutritional quality normally associated with animal meat products primarily due to the lack of certain essential amino acids, vitamins, and minerals.

Plant-based consumables, such as plant-based dairy alternatives and meat analogues, exhibit off-notes associated with plant protein and often do have the same mouthfeel as their animal-based counterparts. There exists a need in the art to provide food and beverage ingredients which can modify the flavour of various plant-based consumables, mask off-notes, and improve the mouthfeel. A need also exists in the art to provide food and beverage ingredients which are natural to provide “clean-label” food products.

### SUMMARY

According to a first illustrative aspect, disclosed is a process for making an additive composition, the process comprising: (a) forming an aqueous mixture of at least one plant-derived protein and, optionally, yeast extract, (b) subjecting the aqueous mixture of the plant-derived protein and yeast extract to enzymatic treatment using at least one proteolytic enzyme, and (c) subjecting the enzymatically treated aqueous mixture of the plant-derived protein and yeast extract to fermentation using one or more microorganism.

According to a second illustrative aspect, provided is an additive composition for a plant-based consumable prepared in accordance with the process of the first illustrative aspect.

According to a third illustrative aspect, provided is a flavour modifying ingredient prepared in accordance with the process of the first illustrative aspect.

According to a fourth illustrative aspect, provided is a postbiotic-containing consumable composition prepared in accordance with the process of the first illustrative aspect.

According to a fifth illustrative aspect, provided is an additive composition for a consumable comprising an enzymatically treated and fermented aqueous mixture of at least one plant-derived protein and, optionally, yeast extract.

According to a sixth illustrative aspect, disclosed is a flavour modifying ingredient comprising an enzymatically treated and fermented aqueous mixture of at least one plant-derived protein and, optionally, yeast extract.

According to a seventh illustrative aspect, postbiotic-containing consumable composition comprising an enzymatically treated and fermented aqueous mixture of at least one plant-derived protein and, optionally, yeast extract.

According to an eighth illustrative aspect, provided is a process for making an additive composition for a plant-based consumable or a flavour modifying ingredient, the process comprising (a) forming an aqueous mixture of at least one plant-derived protein and water, (b) subjecting the aqueous mixture of the plant-derived protein and yeast extract to enzymatic treatment using at least one proteolytic enzyme, and (c) inactivating the at least one proteolytic enzyme.

According to a ninth illustrative aspect, provided is an additive composition for a plant-based consumable prepared in accordance with the process of the eighth illustrative aspect.

According to a tenth illustrative aspect, provided is a flavour modifying ingredient prepared in the accordance with the process of the eighth illustrative aspect.

According to an eleventh illustrative aspect, provided is a process for making an additive composition for a plant-based consumable, a flavour modifying ingredient, or a postbiotic-containing composition, the process comprising (a) forming an aqueous mixture of at least one plant-derived protein and water, (b) subjecting the aqueous mixture of the plant-derived protein and yeast extract to fermentation using at least one microorganism, and (c) inactivating the at least one microorganism.

According to a twelfth illustrative aspect, provided is an additive composition for a plant-based consumable prepared by the process of the eleventh illustrative aspect.

According to a thirteenth illustrative aspect, provided is a flavour modifying ingredient prepared by the process of the eleventh illustrative aspect.

According to a fourteenth illustrative aspect, provided is a postbiotic-containing composition prepared the process of the eleventh illustrative aspect.

According to a fifteenth illustrative aspect, provided is a meat analogue comprising plant-derived protein base and the additive composition prepared by the process of the first illustrative aspect.

According to a sixteenth illustrative aspect, provided is a meat analogue comprising plant-derived protein base and the additive composition prepared by the process of the eighth illustrative aspect.

According to a seventeenth illustrative aspect, provided is a meat analogue comprising plant-derived protein base and the additive composition prepared by the process of the eleventh illustrative aspect.

According to an eighteenth illustrative aspect, provided is a plant-based dairy alternative consumable comprising plant-derived protein base and the additive composition prepared by the process of the first illustrative aspect.

According to a nineteenth illustrative aspect, provided is a plant-based dairy alternative consumable comprising plant-derived protein base and the additive composition prepared by the process of the eighth illustrative aspect.

According to twentieth illustrative aspect, provided is a plant-based dairy alternative consumable comprising plant-derived protein base and the additive composition prepared by the process of the eleventh illustrative aspect.

According to a twenty-first illustrative aspect, provided is a method of improving the taste of a plant-based consumable comprising adding to the plant-based consumable an effective amount of the additive composition prepared by the process of the first illustrative aspect.

According to a twenty-second illustrative aspect, provided is a method of improving the taste of a plant-based consumable comprising adding to the plant-based consumable an effective amount of the additive composition prepared by the process of the eighth illustrative aspect.

According to a twenty-third illustrative aspect, provided is a method of improving the taste of a plant-based consumable comprising adding to the plant-based consumable an effective amount of the additive composition prepared by the process of the eleventh illustrative aspect.

According to a twenty-fourth illustrative aspect, provided is a method of improving the mouthfeel of a plant-based consumable comprising adding to the plant-based consumable an effective amount of the additive composition prepared by the process of the first illustrative aspect.

According to a twenty-fifth illustrative aspect, provided is a method of improving the mouthfeel of a plant-based consumable comprising adding to the plant-based consumable an effective amount of the additive composition prepared by the process of the eighth illustrative aspect.

According to a twenty-sixth illustrative aspect, provided is a method of improving the mouthfeel of a plant-based consumable comprising adding to the plant-based consumable an effective amount of the additive composition prepared by the process of the eleventh illustrative aspect.

According to a twenty-seventh illustrative aspect, provided is a method of conferring a health benefit to a subject comprising adding to a plant-based consumable an effective amount of the additive composition prepared by the process of the first illustrative aspect; and permitting the subject to ingest the plant-based consumable.

According to a twenty-eighth illustrative aspect, provided is a method of conferring a health benefit to a subject comprising adding to a plant-based consumable an effective amount of the additive composition prepared by the process of the eleventh illustrative aspect; and permitting the subject to ingest the plant-based consumable.

According to a twenty-ninth illustrative aspect, provided is the use of the additive composition prepared by the process of any one of the first, eighth or eleventh illustrative aspects to improve the taste of a plant-based consumable.

According to a thirtieth illustrative aspect, provided is the use of the additive composition prepared by the process of any one of the first, eighth or eleventh illustrative aspects to improve the mouthfeel of a plant-based consumable.

According to a thirty-first illustrative aspect, provided is the use of the additive composition prepared by the process of any one of the first or eleventh illustrative aspects to confer a health benefit to a subject.

### DETAILED DESCRIPTION

The following text sets forth a broad description of numerous illustrative embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those recited elements but may include other elements not expressly listed, recited, or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. According to certain illustrative embodiments, these terms are defined to be within 10% of recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value. According to other illustrative embodiments, the terms “about,” “approximately,” “essentially,” “substantially,” any other version thereof, or any other similar relative term, or similar term of approximation, includes at least the degree of error associated with the measurement of the particular value. According to other illustrative embodiments, one of ordinary skill in the art would understand the terms “about,” “approximately,” “essentially,” “substantially,” any other version thereof, or any other similar relative term, or similar term of approximation, as used herein to mean that an amount of a recited value that produces the desired degree of effectiveness in the compositions and/or methods of the present disclosure. One of ordinary skill in the art would further understand that the metes and bounds of the terms “about,” “approximately,” “essentially,” “substantially,” any other version thereof, or any other similar relative term, or similar term of approximation, with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure.

All compositional weight percentages disclosed herein are based on the total weight of the flavour composition and consumable products, as the situation dictates. It will be understood to one of ordinary skill in the art that the total weight percent of the flavour composition or consumable product cannot exceed 100%. For example, a person of ordinary skill in the art would easily recognize and understand that a flavour composition comprising 50 to 95 weight percent of a plant-based protein, 5 to 50 weight percent yeast extract, and 20 to 50 weight percent water will not exceed 100%. A person of ordinary skill in the art would understand that the amount of the components may be adjusted to include the desired amount of component without exceeding 100% by weight of the flavour composition or consumable product.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

When a concentration is expressed as “ppm”, the concentration is parts per million by weight based on the total weight of the consumable. It should be understood that when a range of values is described in the present disclosure, it is intended that any and every value within the range, including the end points, is to be considered as having been disclosed. For example, “a range of from 1 ppm to 1000 ppm” of a component of the composition is to be read as indicating each and every possible number along the continuum between 1 and 1000. It is to be understood that the inventors appreciate and understand that any and all values within the range are to be considered to have been specified, and that the inventors have possession of the entire range and all the values within the range.

For the avoidance of doubt, preferences, options, particular features and the like indicated for a given aspect, feature or parameter of the invention should, unless the context indicates otherwise, be regarded as having been disclosed in combination with any and all other preferences, options particular features and the like as indicated for the same or other aspects, features and parameters of the invention.

According to certain illustrative embodiments, the flavour composition and the consumables containing the flavour composition may be considered to be “clean-label” products. The “clean-label” movement is a consumer movement or trend driven by health and nutrition conscious consumers. The term “clean-label” is a term that has been adopted by the food industry, consumers, academics, and governmental regulatory agencies. A “clean-label” product is a consumable product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

The term “mouthfeel” refers to the complexity of perceptions experienced in the mouth as influenced by the aroma, taste, and texture qualities of food and beverage products. From a technical perspective, however, mouthfeel sensations are specifically associated with physical (e.g. tactile, temperature) and/or chemical (e.g. pain) characteristics perceived in the mouth via the trigeminal nerve. Accordingly, they are a consequence of oral-tactile stimulations and involve mechanical, pain and temperature receptors located in the oral mucosa, lips, tongue, cheeks, palate, and throat. Mouthfeel is considered to be distinct from aroma and taste, but is considered to have an equal or even greater impact on a person's enjoyment or preference for certain foods over others. Mouthfeel perceptions include, for example, astringent, burning, cold, tingling, thick, biting, fatty, oily, slimy, foamy, melting, sandy, chalky, watery, acidic, lingering, metallic, body, body sweet, carbonation, cooling, warming, hot, juicy, mouth drying, numbing, pungent, salivating, spongy, sticky, fullness, cohesiveness, density, fracturability, graininess, grittiness, gumminess, hardness, heaviness, moisture absorption, moisture release, mouthwatering, mouthcoating, roughness, slipperiness, smoothness, uniformity, uniformity of bite, uniformity of chew, viscosity, fast-diffusion, full body, salivation and retention.

The phrase “improvement of mouthfeel” means that any one or more of desired mouthfeel perceptions is/are enhanced and/or that any one or more undesirable mouthfeel perceptions is/are reduced.

According to the International Scientific Association for Probiotics and Prebiotics (“ISAPP”), the term “postbiotic” is defined as “a preparation of inanimate microorganisms and/or their components that confers a health benefit on the host”. The inventors adopt the ISAPP definition of “postbiotics” for purposes of this disclosure. “Postbiotics” may also be referred to in the literature of the art as paraprobiotics, non-viable probiotics, heat-killed probiotics and tyndallized probiotics. A composition comprising a postbiotic possesses an advantage over probiotics in view of manufacturing processes. A postbiotic may be, and in most illustrative embodiments is, treated to kill the organism before it is added to a product. On the other hand, a probiotic to be effective must be kept live and high amounts of live organisms must be added to a product, so that they survive the acidic environment of the human stomach.

Postbiotics include vitamins, minerals, co-factors, proteins, peptides, amino acids, lipids, carbohydrates, organic acids, cell wall components and other complex molecules that confer a health benefit to a host.

Disclosed is an additive or ingredient for a plant-based consumable that functions to improve the taste profile and mouthfeel of a plant-based consumable as compared to the counterpart plant-based consumable without the additive. The additive or ingredient contains a postbiotic that also confers or provides a health benefit to a subject that consumes the plant-based consumable containing the additive.

According to certain embodiments, the additive or ingredient comprises an enzymatically treated and fermented aqueous mixture of at least one plant-derived protein, optionally yeast extract, and water.

According to certain embodiments, the additive or ingredient comprises an enzymatically treated and fermented aqueous mixture of at least one plant-derived protein, optionally yeast extract, a nutritional yeast, and water.

Also disclosed is a process for preparing the additive or ingredient for a plant-based consumable. The process for making an additive composition comprises (a) forming an aqueous mixture of at least one plant-derived protein and, optionally, a yeast extract, (b) subjecting the aqueous mixture of the plant-derived protein and optionally the yeast extract to enzymatic treatment using at least one proteolytic enzyme, and (c) subjecting the enzymatically treated aqueous mixture of the plant-derived protein and optionally the yeast extract to fermentation using one or more microorganism. According to certain embodiment, the process for making an additive composition comprises (a) forming an aqueous mixture of at least one plant-derived protein, optionally a yeast extract and nutritional yeast, (b) subjecting the aqueous mixture of the plant-derived protein and optionally the yeast extract to enzymatic treatment using at least one proteolytic enzyme, and (c) subjecting the enzymatically treated aqueous mixture of the plant-derived protein and optionally the yeast extract to fermentation using one or more microorganism.

According to certain illustrative embodiments, the one or more plant proteins are present in an amount of about 0.5 weight percent to about 30 weight percent, or about 1 weight percent to about 30 weight percent, or about 5 weight percent to about 30 weight percent, or about 10 weight percent to about 30 weight percent, or about 15 weight percent to about 30 weight percent, or about 20 weight percent to about 30 weight percent, or about 25 weight percent to about 30 weight percent, or about 0.1 weight percent to about 25 weight percent, or about 2 weight percent to about 25 weight percent, or about 5 weight percent to about 25 weight percent, or about 10 weight percent to about 25 weight percent, or about 15 weight percent to about 25 weight percent, or about 20 weight percent to about 25 weight percent, or about 0.5 weight percent to about 20 weight percent, or about 1 weight percent to about 20 weight percent, or about 5 weight percent to about 20 weight percent, or about 10 weight percent to about 20 weight percent, or about 15 weight percent to about 20 weight percent, or about 0.5 weight percent to about 15 weight percent, or about 1 weight percent to about 15 weight percent, or about 5 weight percent to about 15 weight percent, or about 10 weight percent to about 15 weight percent, or about 5 weight percent to about 17 weight percent, or about 6 weight percent to about 16 weight percent, or about 6.5 weight percent to about 15.5 weight percent, or any other suitable range between about 0.5 weight percent and 30 weight percent, based on the total weight of the aqueous mixture.

According to certain illustrative embodiments, the yeast extract is present in an amount of greater than 0 weight percent to about 25 weight percent, or greater than 0 weight percent to about 20 weight percent, or greater than 0 weight percent to about 15 weight percent, or greater than 0 weight percent to about 10 weight percent, or greater than 0 weight percent to about 5 weight percent, or greater than 0 weight percent to about 4 weight percent, or greater than 0 weight percent to about 3 weight percent, or greater than 0 weight percent to about 2 weight percent, or greater than 0 weight percent to about 1 weight percent, or about 5 weight percent to about 25 weight percent, or about 5 weight percent to about 20 weight percent, or about 5 weight percent to about 15 weight percent, or about 5 weight percent to about 10 weight percent, or about 10 weight percent to about 25 weight percent, or about 10 weight percent to about 20 weight percent, or about 10 weight percent to about 15 weight percent, or any other suitable range between greater than 0 to about 25 weight percent, or any other suitable range between greater than 0 and 25 weight percent, based on the total weight of the aqueous mixture.

According to certain illustrative embodiments that further include nutritional yeast, the nutritional yeast is present in an amount of about of greater than 0 weight percent to about 25 weight percent, or greater than 0 weight percent to about 20 weight percent, or greater than 0 weight percent to about 15 weight percent, or greater than 0 weight percent to about 10 weight percent, or greater than 0 weight percent to about 5 weight percent, or greater than 0 weight percent to about 4 weight percent, or greater than 0 weight percent to about 3 weight percent, or greater than 0 weight percent to about 2 weight percent, or greater than 0 weight percent to about 1 weight percent, or about 5 weight percent to about 25 weight percent, or about 5 weight percent to about 20 weight percent, or about 5 weight percent to about 15 weight percent, or about 5 weight percent to about 10 weight percent, or about 10 weight percent to about 25 weight percent, or about 10 weight percent to about 20 weight percent, or about 10 weight percent to about 15 weight percent, or any other suitable range between greater than 0 to about 25 weight percent, or any other suitable range between greater than 0 and 25 weight percent, based on the total weight of the aqueous mixture.

According to certain illustrative embodiments, the water used to prepare the aqueous mixture is from about 60 weight percent to about 95 weight percent, or about 60 weight percent to about 90 weight percent, or about 60 weight percent to about 85 weight percent, or about 60 weight percent to about 80 weight percent, or about 60 weight percent to about 75 weight percent, or about 60 weight percent to about 70 weight percent, or about 60 weight percent to about 60 weight percent, or about 70 weight percent to about 95 weight percent, or about 60 weight percent to about 90 weight percent, or about 70 weight percent to about 85 weight percent or about 60 weight percent to about 80 weight percent, or about 70 weight percent to about 75 weight percent, or than other range between about 60 weight percent and about 95 weight percent, based on the total weight of the aqueous mixture.

The one or more plant proteins are fermented with one or more probiotics. Without limitation, and only by way of illustration, suitable microbial strains useful as probiotics for fermentation with the one or more plant proteins include Bifidobacterium animalis (including Bifidobacterium animalis subspecies lactis), Bifidobacterium brevis, Bifidobacterium infantis Bifidobacterium longum, Enterococcus faecalis, Lactobacillus acidophilus, Lactobacillus brevis, Lactobacillus bulgaricus, Lactobacillus casei, Lactobacillus delbrueckii subsp. Bulgaricus, Lactobacillus fermentum, Lactobacillus johnsonii, Lactobacillus paracasei, Lactiplantibacillus plantarum, Lactobacillus rhamnosus, Lactobacillus reuteri, Lactobacillus salivarius, Lactococcus lactis, and Streptococcus salivarius subspecies thermophilus. Suitable probiotic microbial cultures for fermentation with plant proteins include Vega Premium, Vega Vibe, Vega Harmony, Vega Classic and Vega Mild (commercially available from Chr. Hansen). Particularly suitable probiotic microbial strains commercially available from Chr. Hansen include Bifidobacterium animalis subspecies lactis BB-12, Lactobacillus casei 431, Lactobacillus rhanmosus LGG, and those commercially available from Fonterra include Lactobacillus rhamnosus HN001 and Bidifobacterium animalis subspecies lactis HN019.

According to illustrative embodiments, the flavour composition may be provided in the form of spray-dried particles. The flavour composition is spray-dried in combination with a carrier material. Suitable carrier materials include, without limitation, gums such as gelan gum, guar gum, tara gum, xanthan gum, locust bean gum and gum Arabic, agarose, agar-agar, alginate, konjac, pectin, carrageenan, and the like.

The flavour composition may be used to prepare a vegetarian or vegan consumable product. The vegetarian or vegan consumable comprises a “plant derived protein” and the flavour composition. The term “plant derived protein” refers to protein preparations derived from raw materials including, but not limited to, cereal (such as, without limitation, rice, millet, maize, barley, wheat, oat, sorghum, rye, teff, triticale, amaranth, buckwheat, quinoa); legumes or pulses, beans (such as, without limitation, canelli beans, soy beans, mung beans, fava beans, lima beans, runner beans, kidney beans, navy beans, pinto beans, adzuki beans, lentil beans, white beans, and the like), peas (such as, without limitation, green peas, yellow peas, chick peas, pigeon peas, cowpeas, and black-eyed peas and the like); potatoes; seed and oilseed (such as, without limitation, black mustard, India mustard, rapeseed, canola, safflower, sunflower seed, flax seed, hemp seed, poppy seed, pumpkin, chia, sesame); nuts (such as, without limitation, almonds, walnuts, Brazil nuts, Macadamia nuts, cashews, chestnuts, hazelnuts, pine nuts, pecans, peanuts, pistachio and gingko); plant leaves; algal (such as, without limitation, kelp, wakame, spirulina, chlorella); fruit-derived protein, such as green banana; mycoprotein or fungal protein, and combinations thereof; and yeast protein.

According to certain illustrative embodiments, rather than obtaining the plaint-protein from a raw material plant source, the plant-protein may be derived from a food product such as, without limitation, seitan, tempeh, or tofu.

According to certain illustrative embodiments, the process of preparing the additive composition comprises subjecting a plant-based protein to enzymatic hydrolysis followed by subjecting the enzymatically treated protein to fermentation.

According to certain illustrative embodiments, the process of preparing the additive composition comprises subjecting a plant-based protein to fermentation and does not comprise subjecting the plant-based protein to enzymatic hydrolysis.

According to certain illustrative embodiments, the process of preparing the additive composition comprises subjecting a plant-based protein to enzymatic hydrolysis and does not comprise subjecting the plant-based protein to fermentation.

### Enzyme Treatment

According to certain illustrative embodiments, the enzymatic treatment comprises enzymatic hydrolysis. Enzymatic hydrolysis uses one or more enzymes selected from proteolytic enzymes.

Proteolytic enzymes catalyse the hydrolysis of proteins and peptides. Proteolytic enzymes include, for example, proteinases, which hydrolyze proteins to form small peptides, and peptidases, which further hydrolyze small peptides to release amino acids. The proteolytic enzyme(s) may, for example, have endopeptidase activity (attack internal peptide bonds) and/or exopeptidase activity (attack peptide bonds at the end of the protein or peptide such as amino- or carboxypeptidases).

Proteolytic enzymes include, for example, protease, peptidase, glutaminase (e.g. L-glutamine-amido-hydrolase (EC 3.5.1.2)), endoprotease, serine endopeptidase, subtilisin peptidase (EC 3.4.21.62), serine protease, threonine protease, cysteine protease, aspartic acid protease, glutamic acid protease, trypsin, chymotrypsin (EC 3.4.21.1), pepsin, papain, and elastase.

Proteolytic enzymes (EC 3.4 and EC 3.5) are classified by an EC number (enzyme commission number), each class comprises various known enzymes of a certain reaction type. EC 3.4 comprises enzymes acting on peptide bonds (peptidases/proteinases) and EC 3.5 comprises enzymes that act on carbon-nitrogen bonds other than peptide bonds.

Examples for EC 3.4 include, for example, the following: aminopeptidase (EC 3.4.11), dipeptidase (3.4.13), dipeptidyl-peptidase (3.4.14), peptidyl-dipeptidase (3.4.15), serine-carboxypeptidase (3.4.16), metallocarboxypeptidase (3.4.17), cysteine-carboxypeptidase (3.4.18), omegapeptidase (3.4.19), serine-endopeptidase (3.4.21), cysteine-endopeptidase (3.4.22), aspartate-endopeptidase (3.4.23), metalloendopeptidase (3.4.24), threonine-endopeptidase (3.4.25).

Examples for EC 3.5 include, without limitation, proteolytic enzymes that cleave in linear amides (3.5.1), for example, without limitation, glutaminase (EC 3.5.1.2) and protein glutaminase (eg protein Glutaminase®500 from Amano).

Laccases (EC 1.10.3.2) may be used for the enzyme treatment of the plant proteins. Laccases are multicopper oxidases derived from bacteria, fungi and plants which oxidizes phenols and diamines and lead to crosslinking.

Various proteolytic enzymes, suitable for food-grade applications, are commercially available from suppliers such as Novozymes, Amano, Biocatalysts, Bio-Cat, Valey Research (now subsidiary of DSM), EDC (Enzyme Development Corporation), and others. Some non-limiting examples include: Neutrase®, Alcalase®, Protamex®, and Flavorzyme®, Protana® Prime (exo-peptidase blend), and Protana® UBoost (glutaminase) (available from Novozymes); the Promod® series: e.g. 215P, 278P, 279P, 280P, 192P, and 144P, Flavorpro® 192, Peptidase 433P, and Peptidase 436P (available from Biocatalysts); Protin PC10, Umamizyme®, Peptidase R (or 723), Peptidase A, Peptidase M, Peptidase N, Peptidase P, Peptidase S, Acid protease II, and Thermoase GL30 (available from Amano); Peptidase 600 (available from Bio-Cat); Validase® AFP and Validase® FPII (available from Valey Research); Fungal protease, Exo-protease, Papain, Bromelain, and the Enzeco® series of proteases and peptidases (available from EDC).

The amount of enzyme for the enzyme treatment of the plant protein is selected to ensure sufficient activity and depends on the activity of the enzyme(s), amount of substrate, and the reaction conditions. The necessary amount of enzyme can be determined by trying out different amounts and evaluating the sensorial characteristics of the resulting product.

The one or more enzymes used in the enzyme treatment may be used in an amount in the range from greater than 0 weight percent to about 1 weight percent, based on the total weight of the plant protein. For example, and without limitation, the enzymes may be used in an amount ranging from about 0.001 weight percent to about 1 weight percent, or from about 0.0002 weight percent to about 1 weight percent, or from about 0.0003 weight percent to about 1 weight percent, or from about 0.0004 weight percent to about 1 weight percent, or from about 0.0005 weight percent to about 1 weight percent, or from about 0.0005 weight percent to about 0.1 weight percent, or from about 0.0005 weight percent to about 0.2 weight percent, or from about 0.0005 weight percent to about 0.3 weight percent, or from about 0.0005 weight percent to about 0.4 weight percent, or from about 0.0005 weight percent to about 0.6 weight percent, or from about 0.0005 weight percent to about 0.7 weight percent, or from about 0.0005 weight percent to about 0.8 weight percent, or from about 0.0005 weight percent to about 0.9 weight percent, or any other suitable amount between greater than 0 weight percent and 1 weight percent, based on the total weight of the plant protein.

Without limitation, and only by way of example, the ratio of enzyme:substrate may be in the range from about 1:30, or 1:25, or 1:20, or 1:15, or 1:10, or 1:5, or 1:4, or 1:3, or 1:2, or 1:1.

According to certain illustrative embodiments, the enzymatic treatment is performed at a temperature in the range of about 25° C. to about 60° C., or in the range of about 25° C. to about 55° C., or in the range of about 25° C. to about 50° C., or in the range of about 25° C. to about 45° C., or in the range of about 25° C. to about 40° C., or in the range of about 25° C. to about 35° C., or in the range of about 30° C. to about 60° C., or in the range of about 30° C. to about 55° C., or in the range of about 30° C. to about 50° C., or in the range of about 30° C. to about 45° C., or in the range of about 30° C. to about 40° C., or in the range of about 35° C. to about 60° C., or in the range of about 35° C. to about 55° C., or in the range of about 35° C. to about 50° C., or in the range of about 35° C. to about 45° C., or any other temperature between in the range of about 25° C. to about 60° C.

The enzymatic treatment of the plant protein may be performed at a pH at which the enzymes do not denature and which is selected to provide a desired reaction rate. The enzymatic treatment may be performed at a pH in the range from about 4 to about 8, or from about 5 to about 8, or from about 6 to about 8, or from, about 5.5 to about 6.5, or from about 6.5 to about 7.5.

According to certain illustrative embodiments, the enzymatic hydrolysis takes place for a period of time ranging from about 1 hour to about 48 hours, or from about 1 hour to about 45 hours, or from about 1 hour to about 40 hours, or from about 1 hour to about 35 hours, or from about 1 hour to about 30 hours, or from about 1 hour to about 25 hours, or from about 1 hour to about 20 hours, or from about 1 hour to about 15 hours, or from about 1 hour to about 10 hours, or from about 1 hour to about 5 hours, or from about 1 hour to about 4 hours, or from about 1 hour to about 3 hours, or from about 1 hour to about 2 hours, or from about 1 hour to about 1.5 hours, or from about 1 hour to about 24 hours, or, from about 1 hour to about 18 hours, or from about 1 hour to about 12 hours, or from about 1 hour to about 6 hours, or any other suitable time ranging from about 1 hour to about 48 hours.

### Fermentation

According to certain embodiments, the plant protein is subjected to fermentation, wherein the plant protein or mixture of more than one plant protein is contacted with one or more fermenting microorganism(s) under conditions and for a period of time suitable for the microorganism(s) to at least partially break down/metabolize the plant protein. The fermentation may use one or more species of microorganism. According to certain embodiments, the fermentation may use one or more lactic acid bacteria such as Lactobacillus plantarum, Lactobacillus casei, Lactobacillus brevis, and Lactobacillus helveticus. In certain embodiments, the fermentation uses Lactobacillus plantarum. For example, the fermentation may use Lactobacillus plantarum, ATCC 14917. The fermentation may, alternatively, use one or more lactic acid bacteria such as Streptococcus thermophiles and/or Lactobacillus acidophilus. The fermentation may, according to certain embodiments, use a Bifidobacterium.

The amount of microorganism is chosen to ensure sufficient activity and depends on the activity of the microorganism, amount of substrate, and conditions it is used in. The necessary amount of microorganism can be determined by trying out different amounts and testing the effect of the resulting product in a sensory evaluation as described herein.

The amount of microorganism(s) used in the fermentation step of the process may be in the range from about 0.01 weight percent to about 1 weight percent, or from about 0.02 weight percent to about 1 weight percent, or from about 0.03 weight percent to about 1 weight percent, or from about 0.04 weight percent to about 1 weight percent, or from about 0.05 weight percent to about 1 weight percent, or from about 0.06 weight percent to about 1 weight percent, or from about 0.07 weight percent to about 1 weight percent, or from about 0.08 weight percent to about 1 weight percent, or from about 0.09 weight percent to about 1 weight percent, or any other suitable range between about 0.01 weight percent and 1 weight percent, based on the total weight of the reaction mixture.

The fermentation will be performed under conditions suitable for all the microorganisms involved (and all enzymes involved if occurring simultaneously with enzymatic hydrolysis). As will be apparent to the skilled person, the temperature and pH should be within a suitable range for fermentation to occur to the desired degree. The incubation length will vary accordingly, with shorter incubations when conditions are nearer to the optimum conditions. Necessary nutrients if required or beneficial for the chosen microorganisms may be present. Subjecting the incubated mixture to agitation, for example by stirring (e.g. at 50 to 500 rpm or 100 to 200 rpm) may improve the fermentation.

The fermentation may be performed at a pH less than the temperature at which the microorganisms denature and may be selected to provide a desired reaction rate. The fermentation may be performed at a pH ranging from about to about 8, or from 4.5 to about 5.5, or about 5 to about 8, or from about 5 to about 7, or from about 6 to about 8, or from about 6.5 to about 7.5.

The fermentation may, for example, be performed at a temperature less than the temperature at which the microorganisms are killed and/or reduced in numbers, and may be selected to provide a desired reaction rate. According to certain illustrative embodiments, the fermentation is performed at a temperature ranging from about 20° C. to about 45° C., or from about 20° C. to about 40° C., or from about 20° C. to about 35° C., or from about 20° C. to about 30° C., or from about 30° C. to about 45° C., or from about 30° C. to about 40° C., or from about 35° C. to about 45° C., or from about 35° C. to about 40° C., or any other suitable temperature in the range from 20° C. to about 45° C. Without limitation, suitable temperature ranges for Lactobacilli, for example, Lactobacillus plantarum, include from about 20° C. to about 40° C., or from about 30° C. to about 40° C., or from about 35° C. to about 40° C., with an optimum of about 36° C. to about 38° C. Without limitation, suitable temperature ranges for Bifidobacteria or lactic acid bacteria, for example, Streptococcus thermophiles and/or Lactobacillus acidophilus include from about 20° C. to about 40° C., or from about 30° C. to about 40° C., or from about 35° C. to about 40° C., with an optimum of about 36° C. to about 38° C. or from about 30° C. to about 35° C. or from about 30° C. to about 37° C.

The fermentation may take place for a period of time until the desired product is formed. According to certain illustrative embodiments, the fermentation takes place for a period of time ranging from about 1 day to about 10 days, or ranging from about 1 day to about 9 days, or ranging from about 1 day to about 8 days, or ranging from about 1 day to about 7 days, or ranging from about 1 day to about 6 days, or ranging from about 1 day to about 5 days, or ranging from about 1 day to about 4 days, or ranging from about 1 day to about 3 days, or ranging from about 1 day to about 2 days, or any other suitable time ranging from about 1 day to about 10 days.

### Pre-Heating of Plant Protein

According to certain illustrative embodiments, the process of preparing additive composition further comprises pre-heating a mixture of one or more plant proteins to a temperature that is optimal reaction temperature for the enzymes being added. Without limitation, and only by way of illustration, the mixture of one or more plant proteins may be pre-heated to a temperature in the range of about 30° C. to about 75° C. prior to the enzymatic hydrolysis and fermentation.

### Enzyme Deactivation

According to certain illustrative embodiments, the process of preparing the additive composition further comprises deactivating the one or more enzymes following the enzymatic hydrolysis of the plant protein. Deactivation of the one or more enzymes used for the enzymatic treatment of the plant proteins may be accomplished by heat treatment at a temperature and for a time sufficient to inactivate or otherwise deactivate the enzymes. By way of example, and not in limitation, deactivation of the one or more enzymes used for the enzymatic treatment of the plant proteins may be accomplished by heat treatment at a temperature of about 110° C. or greater for a time sufficient to deactivate the enzyme. By way of a further example, and not in limitation, deactivation of the one or more enzymes used for the enzymatic treatment of the plant proteins may be accomplished by heat treatment at a temperature of about 120° C. or greater for a time sufficient to deactivate the enzyme. By way of a further example, and not in limitation, deactivation of the one or more enzymes used for the enzymatic treatment of the plant proteins may be accomplished by heat treatment at a temperature of about 110° C. or greater for about 45 minutes to deactivate the enzyme. By way of a further example, and not in limitation, deactivation of the one or more enzymes used for the enzymatic treatment of the plant proteins may be accomplished by heat treatment at a temperature of about 120° C. or greater for about 45 minutes to deactivate the enzyme.

### Microbial Culture Deactivation

According to certain illustrative embodiments, the process of preparing the additive composition further comprises deactivating the one or more fermentation microorganisms following the fermentation. Deactivation of the one or more fermentation microorganisms used for the fermentation of the plant proteins may be accomplished by heat treatment at a temperature and for a time sufficient to inactivate or otherwise deactivate the microorganism(s). By way of example, and not in limitation, deactivation of the one or more microorganisms used for the fermentation of the plant proteins may be accomplished by heat treatment at a temperature of about 100° C. or greater for a time sufficient to deactivate the microorganism(s). By way of a further example, and not in limitation, deactivation of the one or more microorganism(s) used for the fermentation of the plant proteins may be accomplished by heat treatment at a temperature of about 100° C. or greater for about 45 minutes.

According to certain illustrative embodiments, the process of preparing the additive composition further comprises spray-drying the additive composition. The product of the enzymatic hydrolysis and/or fermentation (the additive composition) may, for example, be spray-dried by methods known in the art, for example using carriers and/or anti-caking agents.

### Food and Beverage Products

The flavour composition may be used to prepare a wide variety of non-animal based (for example, plant-based) consumable or ingestible products, consumable or ingestible animal-based products, and hybrid consumable or ingestible products comprising a combination of animal-based components and non-animal based) components.

According to illustrative embodiments, provided is a meat analogue comprising a plant-derived protein and a fermented postbiotic.

According to illustrative embodiments, provided is a plant-based dairy alternative consumable comprising a plant-derived protein and a fermented postbiotic.

Flavour compositions contain the flavour modifying ingredient and optionally one or more food grade excipient. Suitable excipients for flavour compositions are well known in the art and include, for example, without limitation, solvents (including water, alcohol, ethanol, oils, fats, vegetable oil, and miglyol), binders, diluents, disintegrating agents, lubricants, flavouring agents, colouring agents, preservatives, antioxidants, emulsifiers, stabilisers, flavour-enhancers, sweetening agents, anti-caking agents, and the like. Examples of such carriers or diluents for flavours may be found e.g. in “Perfume and Flavour Materials of Natural Origin”, S. Arctander, Ed., Elizabeth, N.J., 1960; in “Perfume and Flavor Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

The consumable may include at least one fat. The at least one fat may be selected from animal-derived fats, plant-derived fats and mixtures thereof. Suitable animal fats include animal-derived butter fats, milk fats, lard, and the like, and mixtures thereof. According to certain embodiments, fat component of the consumable may comprise an oil selected from algal oils, insect oils, vegetable-derived oils and combinations thereof. According to certain embodiments, the fat component comprises one or more vegetable-derived oils. Without limitation, and only by way of illustration, suitable vegetable oils include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

The flavour additive or consumable product may also include at least one prebiotic. Prebiotics promote the growth of beneficial bacteria in the intestines. Prebiotic substances can be consumed by a relevant probiotic, or otherwise assist in keeping the relevant probiotic alive or stimulate its growth. When consumed in an effective amount, prebiotics also beneficially affect the human body's naturally-occurring gastrointestinal microflora and thereby impart health benefits apart from just nutrition. Prebiotic foods enter the colon and serve as substrate for the endogenous bacteria, thereby indirectly providing the host with energy, metabolic substrates, and essential micronutrients.

Without limitation, and only by way of illustration, prebiotics may be selected from mucopolysaccharides, oligosaccharides, polysaccharides, amino acids, vitamins, nutrient precursors, proteins and combinations thereof. According to certain illustrative embodiments, the prebiotic may be selected from dietary fibers. According to further illustrative embodiments, the dietary fibers may be selected from polysaccharides and oligosaccharides. Without limitation, and only by way of illustration, suitable oligosaccharides that are categorized as prebiotics include fructooligosaccharides, inulins, isomalto-oligosaccharides, lactilol, lactosucrose, lactulose, dextrins, soy oligosaccharides, transgalacto-oligosaccharides, and xylo-oligosaccharides. Prebiotics may be obtained from foods such as bananas, berries, asparagus, garlic, wheat, oats, flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

The consumable may further include at least one sweetener in a sweetening-effective amount to impart a desired sweetness to the consumable to which the sweetener is added. The at least one sweetener may comprise at least one caloric sweetener, or at least one non-caloric sweetener, or a combination of at least one caloric sweetener and at least one non-caloric sweeteners. The non-caloric sweeteners may be selected from synthetic non-caloric sweeteners and natural non-caloric sweeteners.

Without limitation, and only by way of illustration, suitable synthetic non-caloric sweeteners include acesulfame K, advantame, aspartame, cyclamate, neotame, neohesperidin dihydrochalcone, saccharin, sucrolose and combinations thereof.

Without limitation, and only by way of illustration, suitable non-caloric natural sweeteners include steviol glycosides selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, and combinations thereof, mogrol glycosides selected from mogroside I, mogroside II, mogroside III, mogroside IV, mogroside V, isomogroside V, 11-oxomogroside, siamenoside I and combinations thereof, Luo Han Guo sweetener, Swingle Extract, erythritol, glycyrrhizic acid, thaumatin, brazzein, monatin and combinations thereof.

Without limitation, and only by way of illustration, suitable caloric sweeteners include sucrose, fructose, glucose, high fructose corn syrup, corn syrup, xylose, arabinose, rhamnose, erythritol, xylitol, mannitol, sorbitol, inositol, allulose and combinations thereof.

The dairy-alternative consumables (both the dairy-alternative foods and beverages) may include a thickener. Without limitation, suitable thickeners include agar agar, gum arabic, gellan gum, guar gum, locust bean gum and combination.

The consumable may further include nutritionally effective amounts of at least one vitamin, or at least one mineral or a combination of at least one vitamin and at least one mineral. According to certain embodiments, the consumable comprises a nutritionally effective amount of at least one vitamin. According to certain embodiments, the consumable comprises a nutritionally effective amount of more than one different vitamin. According to certain embodiments, the consumable comprises a nutritionally effective amount of at least one mineral. According to certain embodiments, the consumable comprises a nutritionally effective amount of more than one different mineral. According to certain embodiments, the consumable comprises a nutritionally effective amount of at least one vitamin and at least one mineral. According to certain embodiments, the consumable comprises a nutritionally effective amount of more than one different vitamin and at least one mineral. According to certain embodiments, the consumable comprises a nutritionally effective amount of at least one vitamin and more than one different mineral. According to certain embodiments, the consumable comprises a nutritionally effective amount of more than one different vitamin and more than one different mineral.

The consumable may further include a sufficient amount of at least one preservative to prevent decomposition and/or microbial growth. Illustrative preservatives include, without limitation, ascorbic acid, benzoic acid, butylated hydoxyanisole (BHA), butylated hydroxytoluene (BHT), citric acid, disodium ethylenediaminetetraacetic acid (EDTA), sorbic acid, ascorbates, benzoates, nitrates, nitrites, polyphosphates, propionates, sorbates, sulfites and tocopherol. According to certain embodiments, for “clean label” products sodium salt may be used as the sole preservative.

Without limitation, and only by way of illustration, the consumable may comprise food products and beverage products. According to certain illustrative embodiments, food products include dairy food products that contain dairy protein derived from animals and dairy-alternative food beverages that contain protein derived from plant sources instead of from animal sources. Exemplary dairy-alternative food products include non-dairy cheese, non-dairy cottage cheese, non-dairy cream cheese, non-dairy cheese dips, non-dairy ice cream, non-dairy sour cream, and non-dairy yogurt.

According to certain illustrative embodiments, the consumable is selected from the group consisting of non-dairy milk, non-dairy milk beverages, non-dairy coffee creamer, non-dairy cream, almond milk, banana milk, cashew milk, coconut milk, flax milk, hazelnut milk, oat milk, hemp milk, lupin milk, macadamia milk, pea milk, peanut milk, pistachio milk, quinoa milk, rice milk, sesame milk, soy milk, spelt milk, walnut milk, mixtures of more than one plant milk, non-dairy lassi, non-dairy yogurt beverages, non-dairy yogurt drinks, non-dairy drinking yogurt beverages, non-dairy probiotic drinking yogurt beverages, non-dairy yogurt smoothies, and the like.

Dairy beverages containing dairy protein derived from animals include, but are not limited to, milk, fluid milk, cultured milk, cultured and noncultured dairy-based drinks, lassi, milk shake, acidified milk, acidified milk beverage, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed milk, evaporated milk, reduced milk, plain condensed milk, plain evaporated milk, whole milk, skim milk, low fat milk, nonfat milk, flavoured milk drinks, dairy only flavoured milk drinks, sour milk drinks, fermented dairy drinks, coffee whiteners, powder milk, and flavoured powder milk drinks.

According to certain illustrative embodiments, the flavour composition may be used to prepare a wide variety of consumable non-animal based meat analogue, meat replica, or meat substitute products. Meat analog products are produced with high moisture content and provide a product that simulates the fibrous structure of animal meat and has a desirable meat-like moisture, texture, mouthfeel, flavor and color. Without limitation, and only by way of example, suitable consumable meat analogue products include plant-based hot dogs, burgers, ground meat, sausage links, sausage patties, steaks, filets, roasts, breasts, thighs, wings, meatballs, meatloaf, bacon strips, fingers, nuggets, cutlets, and cubes.

Texturization of protein is the development of a texture or a structure via a process involving heat, and/or shear and the addition of water. The texture or structure will be formed by protein fibers that will provide a meat-like appearance and perception when consumed. The mechanism of texturization of proteins starts with the hydration and unfolding of a given protein by breaking intramolecular binding forces by heat and/or shear. The unfolded protein molecules are aligned and bound by shear, forming the characteristic fibers of a meat-like product. In one embodiment, polar side chains from amino acids form bonds with linear protein molecules and the bonds will align protein molecules, forming the characteristic fibers of a meat-like product.

To make non-animal proteins palatable, texturization into fibrous meat analogs, for example, through extrusion processing has been an accepted approach. Due to its versatility, high productivity, energy efficiency and low cost, extrusion processing is widely used in the modern food industry. Extrusion processing is a multi-step and multifunctional operation, which leads to mixing, hydration, shear, homogenization, compression, deaeration, pasteurization or sterilization, stream alignment, shaping, expansion and/or fiber formation. Ultimately, the non-animal protein, typically introduced to the extruder in the form of a dry blend, is processed to form a fibrous material.

More recent developments in extrusion technology have focused on using twin screw extruders under high moisture (40-80%) conditions for texturizing non-animal proteins into fibrous meat alternatives. In the high moisture twin screw process, also known as “wet extrusion”, the raw materials, predominantly non-animal proteins such as soy and/or pea protein, are mixed and fed into a twin-screw extruder, where a proper amount of water is dosed in and all ingredients are further blended and then melted by the thermo-mechanical action of the screws. The realignment of large protein molecules, the laminar flow, and the strong tendency of stratification within the extruder's long slit cooling die contribute to the formation of a fibrous structure. The resulting wet-extruded products tend to exhibit improved whole muscle meat-like visual appearance and improved palatability. Therefore, this extrusion technology shows promise for texturizing non-animal proteins to meet increasing consumer demands for healthy and tasty foods.

Texturization processes may also include spinning, simple shear flow, and simple shear flow and heat in a Couette Cell (“Couette Cell” technology). The spinning process consists of unfolding protein molecules in a high alkaline pH solution, and coagulating the unfolded protein molecules by spraying the protein alkaline solution into an acid bath. The spraying is made by a plate with numerous fine orifices. The protein coagulates forming fibers as soon as it gets in contact with the acid medium. The fibers are then washed to remove remaining acid and/or salts formed in the process. A Couette Cell is a cylinder-based device where the inner cylinder rotates and the outer cylinder is stationary, being easy to scale up. The Couette Cell operates under the same principle of forming protein fibers by subjecting the protein to heat and shear in the space between the stationary cylinder and the rotational cylinder.

Meat analog products having qualities (for example, texture, moisture, mouthfeel, flavor, and color) similar to that of whole muscle animal meat may be produced using non-animal proteins formed using extrusion under conditions of relatively high moisture. In one embodiment, meat analog products may include non-animal protein, one or more of flour, starch, and edible fiber, an edible lipid material.

In certain compositions, the amount of non-animal protein included in the mixture to be extruded includes no more than about 90% by weight of the dry ingredients. For example, the amount of non-animal protein present in the ingredients utilized to make meat analog products according to the present disclosure may range from about 3% to about 90% by weight of the dry ingredients. In another embodiment, the amount of non-animal protein present in the ingredients utilized to make meat analog products according to the present disclosure may range from about 10% to about 80% by weight of the dry ingredients. In a further embodiment, the amount of non-animal protein present in the dry ingredients utilized to make meat analog products according to the present disclosure may range from about 25% to about 50% by weight. In another further embodiment, the amount of non-animal protein present in the dry ingredients utilized to make meat analog products according to the present disclosure may be about 40%.

The term “dry ingredients” includes all the ingredients in the mixture to be extruded except for added water and ingredients added with the added water (i.e., the “wet ingredients”).

In addition to the foregoing, the meat analog product includes water at a relatively high amount. In one embodiment, the total moisture level of the mixture extruded to make the meat analog product is controlled such that the meat analog product has a moisture content that is at least about 50% by weight. To achieve such a high moisture content, water is typically added to the ingredients. Although, a relatively high moisture content is desirable, it may not be desirable for the meat analog product to have a moisture content much greater than about 65%. As such, in one embodiment the amount of water added to the ingredients and the extrusion process parameters are controlled such that the meat analog product (following extrusion) has a moisture content that is from about 40% to about 65% by weight.

Among the suitable extrusion apparatuses useful in the practice of the described process is a commercially available double barrel, twin-screw extruder apparatus such as a Wenger TX 52 model manufactured by Wenger (Sabetha, Kans.). The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus; however, it is typically from about 100 to about 450 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding non-animal protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. to about 70° C. In one embodiment, the dry premix is transferred through multiple heating zones within the extrusion apparatus, with the protein mixture heated to a temperature of from about 25° C. to about 170° C. such that the molten extrusion mass enters the extrusion die at a temperature of from about 170° C. In one embodiment, the protein mixture is heated in the respective heating zones to temperatures of about 25° C., about 40° C., about 95° C., about 150° C. and about 170° C.

The pressure within the extruder barrel is typically between about 30 psig and about 500 psig, or more specifically between about 50 psig and about 300 psig. Generally, the pressure within the last two heating zones is between about 50 psig and about 500 psig, even more specifically between about 50 psig to about 300 psig. The barrel pressure is dependent on numerous factors including, for example, the extruder screw speed, feed rate of the mixture to the barrel, feed rate of water to the barrel, and the viscosity of the molten mass within the barrel.

Water along with additional “wet ingredients” are injected into the extruder barrel to hydrate the non-animal protein mixture and promote texturization of the proteins. As an aid in forming the molten extrusion mass, the water may act as a plasticizing agent. Water may be introduced to the extruder barrel via one or more injection jets. The rate of introduction of water to the barrel is generally controlled to promote production of an extrudate having the aforementioned desired characteristics, such as an extrudate with a moisture content as described above.

Textured vegetable proteins (TVPs) can be defined as food products made from edible protein sources and characterised by having structural integrity and identifiable texture such that each unit will withstand hydration in cooking and other procedures used in preparing the food for consumption. A majority of TVPs produced today are produced by extrusion technology. These TVPs are often rehydrated with 60-65% moisture and blended with other ingredients including, but not limited to, binders, meats, other TVPs, flavours, excipient, fats, oils, or seasonings.

The low-moisture meat analog (LMMA) product is most often cut with an extruder knife at the extruder die to form the finished product size and shape. Drying after extrusion, to remove moisture, improves storage, handling, and shelf-stability. These LMMAs are often rehydrated with 60-70% moisture. Additionally, other food ingredient items can be added to improve finished product functionality and appearance, including, but not limited to, oil, other proteins, salt, seasonings, flavours, maskers, enhancers, or binders. Generally re-hydrated LMMA contains 40-80% moisture, 0-5% oil, 25-60% protein.

According to certain illustrative embodiments, the consumable comprises a plant-based burger patty comprising a plant protein base and the flavour composition. Without limitation, the plant-based burger patty may comprise a textured vegetable protein that is combined with an effective amount of the flavour composition.

According to other illustrative embodiments, the burger patty may be a reduced animal protein burger patty where the burger patty base comprises a mixture of animal-based protein and a plant-based protein, such as a textured vegetable protein, as a replacement for a portion of the animal protein, in combination with the flavour composition.

According to other embodiments, a plant-based burger patty incorporating the flavour composition may be prepared by an additive manufacturing or 3D printing process. A digital image of a three-dimensional burger patty is created with 3D modeling computer software. The 3D model of the digital file is then sliced into many thin, 2 dimensional (2D) layers using slicing software and then converted into a set of instructions in machine readable language for the 3D printer to execute. The digital file with the set of instructions in machine readable code is communicated to the additive manufacturing equipment (ie, a 3D printer). The 3D printer prints a burger patty by laying down successive thin layers of materials through one or more nozzles. According to certain embodiments, separate sources of the flavour composition and the edible plant-based protein base of the burger patty are in communication with the 3D printer. The flavour composition and the edible plant-derived protein base are stored in separate containers. Each of the containers are connected to one or more discharge nozzles via a suitable conduit extending between the containers and the nozzles. Upon executing the set of instructions, the 3D printer melts the flavour composition and the plant-derived protein base by moving these materials from the source containers though the conduits to the discharge nozzles. The materials are discharged from the nozzles to lay down successive layers of material to create a built-up 3-dimensional burger patty. According to other embodiments, the separate sources of the flavour and the edible plant-based protein base may be moved via separate conduits to a mixing chamber where the flavour composition is mixed with the protein base, and the mixture discharged from the mixing chamber to one or more discharge nozzles via one or more conduits extending between the mixing chamber and the one or more discharge nozzles. The mixture is then discharged from the one or more discharge nozzles to lay down successive thin, 2-dimensional layers until a 3-dimensional burger patty is formed.

According to certain illustrative embodiments, a plant-based burger patty may be formed by combining together from about 90 weight percent to about 99.9 weight percent of a plant based protein and from about 0.1 weight percent to about 10 weight percent of the flavour composition, based on the total weight of the plant-based burger patty. Illustrative plant-based burger patties may be formed by blending together from about 90 to about 99.75 weight percent of a plant-based protein and from about 0.25 weight percent to about 10 weight percent of the flavour composition, or from about 90 to about 99.5 weight percent of a plant-based protein and from about 0.5 weight percent to about 10 weight percent of the flavour composition, or from about 90 to about 99.25 weight percent of a plant-based protein and from about 0.75 weight percent to about 10 weight percent of the flavour composition, or from about 90 to about 99 weight percent of a plant-based protein and from about 1 weight percent to about 10 weight percent of the flavour composition, or from about 90 to about 98.75 weight percent of a plant-based protein and from about 1.25 weight percent to about 10 weight percent of the flavour composition, or from about 90 to about 98.5 weight percent of a plant-based protein and from about 1.5 weight percent to about 10 weight percent of the flavour composition, or from about 90 to about 98.25 weight percent of a plant-based protein and from about 1.75 weight percent to about 10 weight percent of the flavour composition, or from about 90 to about 98 weight percent of a plant-based protein and from about 2 weight percent to about 10 weight percent of the flavour composition, or from about 90 to about 97 weight percent of a plant-based protein and from about 3 weight percent to about 10 weight percent of the flavour composition, or from about 90 to about 96 weight percent of a plant-based protein and from 4 weight percent to about 10 weight percent of the flavour composition, or from about 90 to about 95 weight percent of a plant-based protein and from about 5 weight percent to about 10 weight percent of the flavour composition, each independently based on the total weight of plant-based burger patty. Burger patties may be cooked in a frying pan for about 1 minute to about 8 minutes on each side, or from about 2 minutes to about 6 minutes on each side, or for about 3 minutes on each side.

The plant-based protein may comprise a textured vegetable protein which is typically provided as a dehydrated product that can be reconstituted with water or another suitable cooking broth or consumable liquid. According to certain embodiments, the desired amount of the reconstituted textured vegetable protein is blended with the desired amount of the flavour composition to prepare a suitable plant-based burger. The textured vegetable protein is usually ground to a smaller size prior to be blended with the flavour composition. The flavour composition is generally comminuted into small pieces for easy blending with the ground and reconstituted textured vegetable protein. The reconstituted textured vegetable protein and the flavour composition are mixed together and then formed into suitable sized burger patties by hand, hand tool, or automated burger patty forming equipment.

### EXAMPLES

### Example 1

An additive composition was prepared. 15 g of chick pea, 150 g of glutathione rich yeast extract, and 800 g of water were combined together to form a mixture of ingredients and the mixture of ingredients was heated to 55° C. 2.6 g of Alcalase, 7 g of Protana Prime, 2.6 g of Protana Boost, and 0.05 g of Laccase were added to the heated mixture of chick pea, yeast extract and water. This mixture was incubated at 55° C. for 1 hour. Following the 1 hour incubation period, the mixture of ingredients was heated to 121° C. for 1 hour to inactivate the enzymes and then the mixture was cooled to 37° C. 1 g of Culture B019 (Bifidobacterium from Fontera) and 1 g of Lactobacillus planturum were added to the mixture of ingredients and the mixture was fermented at 37° C. for 84 hours. The fermented mixture of ingredients was pasteurized at 100° C. for 30 minutes and then cooled to 37° C. The mixture was spray dried using gum Arabic as a carrier.

### Example 2

The organoleptic profile of the additive composition prepared in Example 1 was evaluated in a plant-based protein burger. A plant-based burger was prepared from a dough comprising about 98.5 weight percent plant-based protein and about 1.5 weight percent of the flavour composition of Example 1. The plant-based burger patty was cooked and evaluated by a panel of trained food tasters. The plant-based burger patty was cooked by pan frying in a standard stove-top frying pan. A suitable cooking oil was introduced into the frying pan and heated until hot. The plant-based burger was placed into the hot cooking oil and cooked on one side. The plant-based burger was flipped and cooked from about on a second side, being careful not to burn the burger patty. The cooked burger patty was removed from the frying pan, cut into smaller sample size pieces, and placed on a heated dish or demonstration skillet. The results of the organoleptic evaluation by the trained panel demonstrate that the plant-based burger exhibited good mouthfeel, and the taste profile was described as mineralic, animalic, complex, savoury, salty and umami.

### Example 3

An additive composition was prepared. 29 g of grape fiber, 200 g of chick pea protein, 10 g of mung bean protein, 50 g of nutritional yeast, and 800 g of water were combined together in a glass reactor to form a mixture of ingredients and the mixture of ingredients was heated to 55° C. with agitation. The following enzymes were then added to the heated mixture: 2.6 g of Alcalase, 7 g of Protana Prime, 2.6 g of Protana Boost, and 0.05 g of Laccase. This mixture was incubated at 55° C. for 1 hour. Following the 1 hour incubation period, the mixture of ingredients was heated to 121° C. for 1 hour to inactivate the enzymes and then the mixture was cooled to 37° C. The following bacteria cultures were added to the mixture: 0.5 g of Bifidobacterium Culture B019 (commercially available from Fonterra), 0.5 g of Bifidobacterium Culture BB12 (commercially available from Chr. Hansen), and 0.5 g of Lactobacillus LGG (commercially available from Chr. Hansen), and the mixture was fermented at 37° C. for 48 hours. The fermented mixture of ingredients was pasteurized to inactivate the bacterial cultures at 100° C. for 30 minutes, and then cooled to 37° C.

### Example 4

An additive composition was prepared. 100 g of yeast protein, 100 g of nutritional yeast, and 800 g of water were combined together in a glass reactor to form a mixture of ingredients and the mixture of ingredients was heated to 55° C. with agitation. The following enzymes were then added to the heated mixture: 1.5 g of Alcalase, 3 g of Protana Prime, 1.5 g of Protana Boost, and 0.05 g of Laccase. This mixture was incubated at 55° C. for 1 hour. Following the 1 hour incubation period, the mixture of ingredients was heated to 121° C. for 1 hour to inactivate the enzymes and then the mixture was cooled to 37° C. The following bacteria cultures were added to the mixture: 0.5 g of Bifidobacterium Culture B019 (commercially available from Fonterra), 0.5 g of Bifidobacterium Culture BB12 (commercially available from Chr. Hansen), and 0.5 g of Lactobacillus LGG (commercially available from Chr. Hansen), and the mixture was fermented at 37° C. for 48 hours. The fermented mixture of ingredients was pasteurized to inactivate the bacterial cultures at 100° C. for 30 minutes, and then cooled to 37° C.

### Example 5

An additive composition was prepared. 50 g of green banana powder, 100 g of chick pea protein, 10 g of mung bean protein, 50 g of nutritional yeast, and 800 g of water were combined together in a glass reactor to form a mixture of ingredients and the mixture of ingredients was heated to 121° C. for 1 hour, then cooled to 37° C. The following bacteria cultures were added to the mixture: 0.3 g of Bifidobacterium Culture B019 (commercially available from Fonterra), 0.3 g of Bifidobacterium Culture BB12 (commercially available from Chr. Hansen), and 0.3 g of Lactobacillus LGG (commercially available from Chr. Hansen), and the mixture was fermented at 37° C. for 48 hours with slow agitation. The fermented mixture of ingredients was pasteurized to inactivate the bacterial cultures at 100° C. for 30 minutes, and then cooled to 37° C.

### Example 6

The organoleptic profile of the additive composition prepared in Examples 3-5 were evaluated in a plant-based protein burger. Plant-based burgers were prepared from a dough comprising about 97 weight percent plant-based protein and about 3 weight percent of the additive composition of Examples 3, 4, or 5. The plant-based burger patties were cooked and evaluated by a panel of trained food tasters. The plant-based burger patties were cooked by pan frying in a standard stove-top frying pan. A suitable cooking oil was introduced into the frying pan and heated until hot. The plant-based burgers were placed into the hot cooking oil and cooked on one side. The plant-based burgers were flipped and cooked on a second side, being careful not to burn the burger patties. The cooked burger patties were removed from the frying pan, cut into smaller sample size pieces, and placed on a heated dish or demonstration skillet. The results of the organoleptic evaluation by the trained panel demonstrate that the plant-based burgers exhibited good mouthfeel, a savoury taste, and good masking of off-notes from the plant-based protein.

### Example 7

The organoleptic profile of the additive composition prepared in Examples 3-5 were evaluated in a plant-based protein burger. Plant-based burgers were prepared from a dough comprising about 95 weight percent plant-based protein and about 5 weight percent of the additive composition of Examples 3, 4, or 5. The plant-based burger patties were cooked and evaluated by a panel of trained food tasters. The plant-based burger patties were cooked by pan frying in a standard stove-top frying pan. A suitable cooking oil was introduced into the frying pan and heated until hot. The plant-based burgers were placed into the hot cooking oil and cooked on one side. The plant-based burgers were flipped and cooked on a second side, being careful not to burn the burger patties. The cooked burger patties were removed from the frying pan, cut into smaller sample size pieces, and placed on a heated dish or demonstration skillet. The results of the organoleptic evaluation by the trained panel demonstrate that the plant-based burgers exhibited good mouthfeel, a savoury taste, and good masking of off-notes from the plant-based protein.

### Example 8

An additive composition was prepared. 15 g of chick pea, 15 g of glutathione rich yeast extract, 150 g of nutritional yeast, and 800 g of water were combined together to form a mixture of ingredients and the mixture of ingredients was heated to 55° C. 2.6 g of Alcalase, 7 g of Protana Prime, 2.6 g of Protana Boost, and 0.05 g of Laccase were added to the heated mixture of chick pea, yeast extract, nutritional yeast, and water. This mixture was incubated at 55° C. for 1 hour. Following the 1 hour incubation period, the mixture of ingredients was heated to 121° C. for 1 hour to inactive the enzymes and then the mixture was cooled to 37° C. 1 g of Culture Vega harmony and 1 g of Culture BB12 were added to the mixture of ingredients and the mixture was fermented at 37° C. for 24 hours. The fermented mixture of ingredients was pasteurized at 100° C. for 30 minutes and then cooled to 37° C. The mixture was spray dried using gum Arabic as a carrier.

### Example 9

An additive composition was prepared without fermentation. 100 g of chick pea and 75 g of mung bean protein (MBC080 Henry Broch) were added to a heating vessel and mixed together. 807 g of deionized water was slowly added to the mixture of chick pea powder and mung bean protein and mixed well. The mixture of the chick pea and mung bean protein ingredients and water was heated to 55° C. 6 g of Alcalase, 6 g of Protana Prime, and 6 g of Protana Boost were added to the heated mixture of chick pea powder and mung bean protein, and this mixture was incubated at 55° C. for 2 hours with agitation. Following the 2 hour incubation period, the mixture of ingredients was heated to 121° C. for 45 minutes to inactive the enzymes and then the mixture was cooled to 30° C. The mixture was spray dried using gum Arabic as a carrier (10% carrier).

### Example 10

An additive composition was prepared by fermentation and without enzyme treatment. 100 g of mung bean protein (MBC080 Henry Broch) and 897 g of deionized water was added to a heating vessel and mixed well. The mung bean protein mixture was heated to 121° C. and held that temperature for 1 hour. The heated mixture was cooled to 37° C. The cooled mixture was inoculated with 3 g of Culture B019 (Bifidobacterium from Fontera) and fermented at 37° C. for 48 hours with slow agitation. Following the 48 hour fermentation period, the mixture of ingredients was heated to 110° C. and held at that temperature for 45 minutes to end the fermentation and then the mixture was cooled to 30° C. The mixture was spray dried using gum Arabic as a carrier (50% carrier).

### Examples 11

The organoleptic profile of the additive compositions prepared in Examples 8-10 were evaluated in a vegan cheese sauce, a vegan cheese block, and a commercially available vegan Macaroni & cheese product. 0.2% of the additive composition of Example 8-10 were used to prepare separate vegan cheese sauce, vegan cheese block and vegan Macaroni & cheese samples, and the samples were evaluated by a panel of trained food testers.

Example 11A. The results of the organoleptic evaluation by the trained panel demonstrate that the vegan cheese sauce, vegan cheese block, and vegan Macaroni & cheese samples containing the additive composition of Example 8 exhibited good mouthfeel, and the taste profile was described as cheesiest, salty, less starchy, good masking, nice upfront middle cheesy, cheesy, creamy, phenolic, plastic, waxy; sour low intensity, creamy, lactone coming through upfront, mild yeasty backend aroma sweet, butyric; salty.

Example 11B. The results of the organoleptic evaluation by the trained panel demonstrate that the vegan cheese sauce, vegan cheese block, and vegan Macaroni & cheese samples containing the additive composition of Example 9 exhibited good mouthfeel, and the taste profile was described as very cheesy, nice impact, creamy, salty, masking of protein, less starchy, very good impact, umami linger, mild; creamy, cheesy, waxy, low brothy; high cheese impact, slight sour (like base), slight savory and umami boost; nice cheese intensity build, more butter, umami, long linger; cheddar notes, less lactoney, creamy, sharp acidic upfront, less savory, fruity lactones, backend needs help aroma mild cheddar-like base; salty, cheddary, nice boost.

Example 11C. The results of the organoleptic evaluation by the trained panel demonstrate that the vegan cheese sauce, vegan cheese block, and vegan Macaroni & cheese samples containing the additive composition of Example 10 exhibited good mouthfeel, and the taste profile was described as very salty, good masking of protein, less starchy, cheesy end, cheesy, creamy, waxy, slight brothy; strong cheesy, waxy, ketonic, pushed cheese note, low intensity, slight butter, acidic, cardboard, minimum cheesy notes, some creamy, meaty, yeasty, middle cheesy notes, aroma sweet toasted American-like grilled cheese; slight salty, slight too high lactony.

### Example 12

An additive was prepared. 70 g of Organic Chickpea flour was mixed in the glass reactor with 630 g water to form a slurry. The slurry was heated to 121° C. with constant agitation and held at that temperature for 45 minutes then cooled down to 37° C. 2.1 g of Culture B0019 was added to the mixture and the mixture was fermented at 37° C. with minimal agitation for 48 hours. To end the fermentation the mixture was heated up to 100° C., held at that temperature for 45 min then cooled down and refrigerated. This fermented liquid mixture was then spray-dried on Organic Gum Arabic as the carrier.

### Examples 13A-13D

The organoleptic profile of the additive prepared in Example 12 was evaluated in almond milk, coconut milk, and cashew milk samples. 0.1% of the additive of Example 12 was used to prepare the milk samples, and the samples were evaluated by a panel of trained food testers.

| Silk Brand | Base Commercial | |
|---|---|---|
| Plant Milk | Product | 0.1% Additive Added |
| Example 13A - | Salty | SI sweeter, more salty, creamy |
| Unsweetened | Astringent | Less astringent, more mouthfeel |
| Almond Milk | Woody | Less woody |
| | Light vanilla | Vanilla |
| Example 13B - | Thin/watery | Not watery, creamy mouthfeel |
| Unsweetened | Woody | Masks woody |
| Almond + | Chalky/astringent | Slightly astringent |
| Coconut Milk | coconut | Masks coconut flavor |
| Example 13C - | Too high coconut | Masks coconut/reduced off |
| Unsweetened | Watery | notes in aroma |
| Coconut Milk | Astringent | Creamy milky, more mouthfeel |
| | Metallic | Clean |
| | | Slightly metallic (metallic/iron |
| | | note of milk) |
| Example 13D - | Gummy | More mouthfeel |
| Unsweetened | Tinny | Not tinny |
| Cashew Milk | Nutty | Sweet creaminess |
| | astringent | Reduced astringency |

All of Examples 13A-13D containing 0.1% of the additive exhibit more mouthfeel, particularly a more creamy or creamy/milky mouthfeel, as compared to the base plant milk product without the additive. Examples 13A and 13D further characterize the improved mouthfeel as being a sweet creamy mouthfeel or sweet creaminess.

Each of Examples 13A, 13B and 13C containing 0.1% of the additive are less astringent as compared to the base plant milk product without the additive.

Each of Examples 13A and 13B containing 0.1% of the additive are less woody as compared to the base plant milk product without the additive.

Each of Examples 13B and 13C containing 0.1% of the additive are less coconut as compared to the base plant milk product without the additive.

Examples 13C containing 0.1% of the additive is less metallic as compared to the base plant milk product without the additive.

Example 13D containing 0.1% of the additive is not tinny as compared to the base plant milk product without the additive which was perceived as being tinny.

### Example 14

70 g of Organic Chickpea flour was mixed in the glass reactor with 630 g water to form a slurry. Enzymes Protana Prime (1.3 g), Protana Boost (0.45 g) and Alcalase (0.45 g) were added and the mixture was held at 55° C. for 2 hours with continuous agitation. After this enzymatic treatment step the slurry was heated up to 121° C. and held at that temperature for 45 minutes then cooled down to 37° C. Culture B0019 was added (2.1 g) and fermentation at 37° C. with minimal agitation proceeded for 48 hours. To end the fermentation the mixture was heated to 100° C., held at that temperature for 45 minutes, then cooled down and refrigerated. This fermented liquid intermediate was then spray-dried on Organic Gum Arabic as the carrier.

### Example 15

70 g of Organic Chickpea flour was mixed in the glass reactor with 630 g water to form a slurry. The slurry was heated up to 121° C. with constant agitation and held at that temperature for 45 minutes, then cooled down to 37° C. Culture Vega Harmony was added (2.1 g) to the mixture and fermentation at 37° C. with minimal agitation proceeded for 48 hours. To end the fermentation the mixture was heated to 100° C., held at that temperature for 45 minutes, then cooled down and refrigerated. This fermented liquid intermediate was then spray-dried on Organic Gum Arabic as the carrier.

### Example 16

70 g of Organic Chickpea flour was mixed in the glass reactor with water (630 g) to form a slurry. Enzymes Protana Prime (1.3 g), Protana Boost (0.45 g) and Alcalase (0.45 g) were added and the mixture was held at 55° C. for 2 hours with continuous agitation. After this enzymatic step the slurry was heated to 121° C. and held at that temperature for 45 minutes, then cooled down to 37° C. Culture Vega Harmony was added (2.1 g) and fermentation at 37° C. with minimal agitation proceeded for 48 hours. To end the fermentation the mixture was heated up to 100° C., held for 45 minutes, then cooled down and refrigerated. This fermented liquid intermediate was then spray-dried on Organic Gum Arabic as the carrier.

### Example 17

70 g of Organic Chickpea flour was mixed in the glass reactor with 630 g of water to form a slurry. The slurry was heated up to 121° C. with constant agitation and held at that temperature for 45 minutes, then cooled down to 37° C. Culture BB12 was added (2.1 g) to the mixture and fermentation at 37° C. with minimal agitation proceeded for 48 hours. To end the fermentation the mixture was heated to 100° C., held at that temperature for 45 minutes, then cooled down and refrigerated. This fermented liquid intermediate was then spray-dried on Organic Gum Arabic as the carrier.

### Example 18

70 g of Organic Chickpea flour was mixed in the glass reactor with 630 g of water to form a slurry. Enzymes Protana Prime (1.3 g), Protana Boost (0.45 g) and Alcalase (0.45 g) were added and the mixture was held at 55° C. for 2 hours with continuous agitation. After this enzymatic step the slurry was heated up to 121° C. and held at that temperature for 45 minutes then cooled down to 37° C. Culture BB12 was added (2.1 g) and fermentation at 37° C. with minimal agitation proceeded for 48 hours. To end the fermentation the mixture was heated up to 100° C., held for 45 minutes, then cooled down and refrigerated. This fermented liquid intermediate was then spray-dried on Organic Gum Arabic as the carrier.

### Example 19

70 g of Organic Pea Protein Isolate was mixed in the glass reactor with 630 g of water to form a slurry. The slurry was heated up to 121° C. with constant agitation and held at that temperature for 45 minutes, then cooled down to 37° C. Culture B0019 was added (2.1 g) to the mixture and fermentation at 37° C. with minimal agitation proceeded for 48 hours. To end the fermentation the mixture was heated up to 100° C., held at that temperature for 45 minutes, then cooled down and refrigerated. This fermented liquid intermediate was then spray-dried on Organic Gum Arabic as the carrier.

### Example 20

70 g of Organic Pea Protein Isolate was mixed in the glass reactor with 630 g of water to form a slurry. Enzymes Protana Prime (1.3 g), Protana Boost (0.45 g) and Alcalase (0.45 g) were added and the mixture was held at 55° C. for 2 hours with continuous agitation. After this enzymatic step the slurry was heated to 121° C. and held at that temperature for 45 minutes, then cooled down to 37° C. Culture B0019 was added (2.1 g) and fermentation at 37° C. with minimal agitation proceeded for 48 hours. To end the fermentation the mixture was heated up to 100° C., held for 45 minutes, then cooled down and refrigerated. This fermented liquid intermediate was then spray-dried on Organic Gum Arabic as the carrier.

### Example 21

70 g of Organic Pea Protein Isolate (Org.) was mixed in the glass reactor with 630 g of water to form a slurry. The slurry was heated up to 121° C. with constant agitation and held at that temperature for 45 minutes, then cooled down to 37° C. Culture Vega Harmony was added (2.1 g) to the mixture and fermentation at 37° C. with minimal agitation proceeded for 48 hours. To end the fermentation the mixture was heated to 100° C., held at that temperature for 45 minutes, then cooled down and refrigerated. This fermented liquid intermediate was then spray-dried on Organic Gum Arabic as the carrier.

### Example 22

70 g of Organic Pea Protein Isolate was mixed in the glass reactor with 630 g of water to form a slurry. Enzymes Protana Prime (1.3 g), Protana Boost (0.45 g) and Alcalase (0.45 g) were added and the mixture was held at 55° C. for 2 hours with continuous agitation. After this enzymatic step the slurry was heated to 121° C. and held at that temperature for 45 minutes, then cooled down to 37° C. Culture Vega Harmony was added (2.1 g) and fermentation at 37° C. with minimal agitation proceeded for 48 hours. To end the fermentation the mixture was heated up to 100° C., held for 45 minutes, then cooled down and refrigerated. This fermented liquid intermediate was then spray-dried on Organic Gum Arabic as the carrier.

### Example 23

70 g of Organic Pea Protein Isolate was mixed in the glass reactor with 630 g of water to form a slurry. The slurry was heated up to 121° C. with constant agitation and held at that temperature for 45 minutes, then cooled down to 37° C. Culture BB12 was added (2.1 g) to the mixture and fermentation at 37° C. with minimal agitation proceeded for 48 hours. To end the fermentation the mixture was heated up to 100° C., held at that temperature for 45 minutes, then cooled down and refrigerated. This liquid intermediate was then spray-dried on Organic Gum Arabic as the carrier.

### Example 24

70 g of Organic Pea Protein Isolate was mixed in the glass reactor with water (630 g) to form a slurry. Enzymes Protana Prime (1.3 g), Protana Boost (0.45 g) and Alcalase (0.45 g) were added and the mixture was held at 55° C. for 2 hours with continuous agitation. After this enzymatic step the slurry was heated to 121° C. and held at that temperature for 45 minutes, then cooled down to 37° C. Culture BB12 was added (2.1 g) and fermentation at 37° C. with minimal agitation proceeded for 48 hours. To end the fermentation the mixture was heated up to 100° C., held for 45 minutes, then cooled down and refrigerated. This fermented liquid intermediate was then spray-dried on Organic Gum Arabic as the carrier.

While the flavour composition, the consumable products incorporating the flavour composition, the methods of making the flavour composition and consumable products have been described in connection with various embodiments, it is to be understood that other similar embodiments may be used or modifications and additions may be made to the described embodiments for performing the same function. Furthermore, the various illustrative embodiments may be combined to produce the desired results. Therefore, the flavour composition, the consumable products incorporating the flavour composition, and the methods of making and using the flavour compositions and consumable products should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A process for making an additive composition, the process comprising:
(a) forming an aqueous mixture of at least one plant-derived protein and, optionally, yeast extract;
(b) subjecting the aqueous mixture of the plant-derived protein and, optionally, yeast extract to enzymatic treatment using at least one proteolytic enzyme; and
(c) subjecting the enzymatically treated aqueous mixture of the plant-derived protein and, optionally, yeast extract to fermentation using one or more microorganism.

2. The process of claim 1, wherein the step (a) comprises forming an aqueous mixture of the at least one plant-derived protein, the optional yeast extract and a nutritional yeast.

3. The process of claim 1, further comprising inactivating the at least one proteolytic enzyme prior to step (c) subjecting the enzymatically treated aqueous mixture of the plant-derived protein and, optionally, yeast extract to fermentation using one or more microorganism.

4. The process of claim 1, wherein the plant protein is derived from cereal, legumes, pulses, beans, peas, potatoes, seeds, nuts, plant leaves, seitan, tempeh, tofu, algal, fruit fiber, mycoprotein, fungus, yeast, insects and combinations thereof.

5. The process of claim 1, wherein the amount of the at least one plant-derived protein in the aqueous mixture is from about 0.5 weight percent to about 30 weight percent, based on the total weight of the aqueous mixture and/or the amount of the at least one proteolytic enzyme in the aqueous mixture is from about 0.001 weight percent to about 1 weight percent, based on the total weight of the aqueous mixture.

6. (canceled)

7. The process of claim 1, wherein the ratio of enzyme:substrate is in the range from about 1:30 and/or enzymatic treatment is performed at a temperature in the range of about 25° C. to about 60° C. and/or at a pH in the range from about 4 to about 8 and/or for a period of time ranging from about 1 hour to about 48 hours.

8. (canceled)

9. (canceled)

10. (canceled)

11. The process of claim 1, wherein the amount of the at least one microorganism used in the fermentation step is in the range from about 0.01 weight percent to about 1 weight percent, based on the total weight of the aqueous mixture.

12. (canceled)

13. (canceled)

14. (canceled)

15. (canceled)

16. The process of claim 1, wherein the aqueous mixture is heated to a temperature of 50° C. or greater prior to subjecting the aqueous mixture to enzymatic treatment.

17. The process of claim 1, further comprising heat treating the fermented aqueous mixture at a temperature of about 110° C. or greater for a time sufficient to deactivate the one or more proteolytic enzymes used in the enzyme treatment and/or at a temperature of about 100° C. or greater for a time sufficient to deactivate the one or more microorganisms used in the fermentation.

18. (canceled)

19. An additive composition for a plant-based consumable or a flavour modifying ingredient or a postbiotic-containing consumable composition prepared by the process of claim 1.

20. (canceled)

21. (canceled)

22. An additive composition or a flavour modifying ingredient or a postbiotic-containing consumable composition comprising a fermented, and optionally enzymatically treated, aqueous mixture of at least one plant-derived protein and yeast extract.

23. (canceled)

24. (canceled)

25. (canceled)

26. (canceled)

27. (canceled)

28. A meat analogue comprising:
plant-derived protein base; and
the additive composition or the flavour modifying ingredient or a postbiotic-containing composition of claim 22.

29. (canceled)

30. (canceled)

31. A plant-based dairy alternative composition comprising:
plant-derived protein base; and
the additive composition or the flavour modifying ingredient or a postbiotic-containing composition of claim 22.

32. (canceled)

33. (canceled)

34. (canceled)

35. (canceled)

36. (canceled)

37. (canceled)

38. A method of improving the taste and/or the mouthfeel of a plant-based consumable comprising adding to the plant-based consumable an effective amount of the additive composition prepared by the process of claim 1.

39. (canceled)

40. (canceled)

41. (canceled)

42. (canceled)

43. (canceled)
